(19) United States
(12) Patent Application Publication
(10) Pub. No.: US 2018/0264406 A1
(43) Pub. Date: Sep. 20, 2018

(54) INDUSTRIAL VOC PROCESSING SYSTEM

(71) Applicant: YAO ZHANG, SAN LEANDRO, CA (US)

(72) Inventor: YAO ZHANG, SAN LEANDRO, CA (US)

(21) Appl. No.: 15/458,034

(22) Filed: Mar. 14, 2017

(51) Int. Cl. B01D 53/84; B01D 53/75; B01D 53/72

(52) U.S. Cl. CPC B01D 53/84; B01D 53/75; B01D 2251/95; B01D 2255/804; B01D 53/72

(57) ABSTRACT

The present invention provides an industrial volatile organic compounds (VOC) processing system that includes a first phase processing structure, a second phase processing structure, a sensor detection device and a computer. The first phase processing structure includes a spraying chamber having an array of sprinklers for circularly spraying lytic enzyme solution to the VOC. The second processing structure includes a biodegradation chamber wherein microbial nutrient solution is circularly used for nourishing microbes that gnaw the VOC particles. The sensor detection device includes two detectors, one placed in the inlet side, and the other one placed in the outlet side of the system, detecting the content of the organic gas and sending the data to the computer. The computer calculates and compares in a real time the ratio of the contents of the organic gas in the inlet side and the outlet side. The system according to the present invention effectively eliminate VOC by first applying lytic enzyme solution to VOC and then letting certain microbes gnaw the VOC particles. In this invention, both the lytic enzyme solution and the microbial nutrient solution are circularly used.

### FIELD OF THE INVENTION

The present invention generally relates to the technologies of organic waste gas treatment and environmental protection. More particularly, the invention is a system for processing industrial VOC.

### BACKGROUND OF THE INVENTION

Volatile organic compounds (VOCs) are emitted as gases from certain solids or liquids. VOCs include a variety of chemicals, some of which may have short and long term adverse health effects. Concentrations of many VOCs are consistently higher indoors (up to ten times higher) than outdoors. VOCs are emitted by a wide array of products numbering in the thousands. Organic chemicals are widely used as ingredients in household products. Paints, varnishes; and wax all contain organic solvents, as do many cleaning, disinfecting, cosmetic, degreasing and hobby products. Fuels are made up of organic chemicals. All of these products can release organic compounds while they are used, and, to some degree, when they are stored. Scientists have discovered that levels of about a dozen common organic pollutants to be 2 to 5 times higher inside homes than outside, regardless of whether the homes were located in rural or highly industrial areas. It is also discovered that while people are using products containing organic chemicals, they can expose themselves and others to very high pollutant levels, and elevated concentrations can persist in the air long after the activity is completed.

The sources of VOC include paints, paint strippers and other solvents, wood preservatives, aerosol sprays, cleansers and disinfectants, moth repellents and air fresheners, stored fuels and automotive products, hobby supplies, dry-cleaned clothing, pesticide, building materials and furnishings, office equipment such as copiers and printers, correction fluids and carbonless copy paper, graphics and craft materials including glues and adhesives, permanent markers and photographic solutions. The sources of industrial sector-based VOC are printing (letterpress, offset and gravure printing processes), wood furniture coating, shoemaking, paint manufacturing and metal surface coating. Among them, benzene and toluene are the major species associated with letterpress printing, while ethyl acetate and isopropyl alcohol are the most abundant compounds of other two printing processes. Acetone and 2-butanone are the major species observed in the shoemaking sector. In the industries of paint manufacturing, wood furniture coating and metal surface coating, aromatics is the most abundant group and oxygenated VOCs is the second largest contributor.

The health effects of VOC may include eye, nose and throat irritation; headaches, loss of coordination and nausea; damage to liver, kidney and central nervous system. Some organics can cause cancer in animals, some are suspected or known to cause cancer in humans. Key signs or symptoms associated with exposure to VOCs include conjunctival irritation, nose and throat discomfort, headache, allergic skin reaction, dyspnea, declines in serum cholinesterase levels, nausea, emesis, epistaxis, fatigue, dizziness. The ability of organic chemicals to cause health effects varies greatly from those that are highly toxic, to those with no known health effect. As with other pollutants, the extent and nature of the health effect will depend on many factors including level of exposure and length of time exposed. Among the immediate symptoms that some people have experienced soon after exposure to some organics include: eye and respiratory tract irritation, headaches, dizziness, visual disorders and memory impairment.

At present, the primary approaches for the treatment of VOCs include catalytic combustion, activated carbon adsorption, low temperature plasma, UV irradiation and so on. The catalytic combustion treatment is relatively more effective, but it requires a high concentration of organic waste gas. Since the concentration of organic gases are usually not high enough for combustion, and natural gas assisted combustion is needed, the operation cost for this approach are relatively high. Activated carbon adsorption method is quite effective. However, it relies on the high cost of activated carbon. Another disadvantage is that the timing for replacement cannot be well controlled, and thus periodical replacement causes waste. The elimination efficiency of organic waste gas by low temperature plasma or by ultraviolet light is quite low.

What is desired is a system, incorporated with an exhaust pipe used in industrial shop or plant, for effectively eliminating VOC in the exhaust by first applying lytic enzyme solution to VOC and then letting certain microbes gnaw the VOC particles.

### SUMMARY OF THE INVENTION

One object of the present invention is to provide a system, incorporated in a pipe structure such as an exhaust pipe, that eliminates the VOC while the exhaust is expelled out the building. There is no additional processing equipment is needed outside of the building.

Another object of the invention is to improve the utilization rate of raw materials for VOC treatment by a circular sprinkling system and a circular nourishing system.

Yet another object of the invention is to provide a monitoring system for replacing VOC treatment materials in an effective manner.

The present invention provides an industrial VOC processing system that includes a first processing section, a second processing section, a sensor detection device and a computer. The first processing section and the second processing section are incorporated in a pipe structure. The first processing section includes a spraying chamber wherein an array of sprinklers circularly sprays lytic enzyme solution to the exhaust gas that passes the chamber. The second processing section includes a biodegradation chamber wherein microbial nutrient solution is circularly used for nourishing microbes that gnaw the VOC particles in the exhaust gas. The sensor detection device includes two detectors, one placed in the inlet end, and the other one placed in the outlet end of the system, detecting the content of the organic gas and sending the data to the computer via data cable or Internet. The computer calculates and compares in a real time the ratio of the contents of the organic gas in the inlet and the outlet.

The system according to present invention effectively eliminate VOC by first applying lytic enzyme solution to VOC and then letting certain microbes gnaw the VOC particles. In this invention, both the lytic enzyme solution and the microbial nutrient solution are circularly used.

In one embodiment, the first processing section is a two-layer structure. The upper layer includes an array of nozzles and the lower layer is a chamber through which the exhaust gas passes.

In another embodiment, the bottom of the first section of the pipe and the bottom of the section of the pipe are designed as inclined surfaces.

In another embodiment, the spraying chamber in the first processing section is covered with an activated carbon layer.

In another embodiment, the cracking tank includes an array of paralleled baffles that alternately coupled to the tank's ceiling and bottom. The baffles coupled to the tank's ceiling have identical length and thus the gap between this group of baffles is identical. The solution passes through the gap between the baffle and the tank's bottom. The height of the baffles coupled to the tank's bottom gradually decreases from the inlet side to the outlet side. Each baffle's height is less than the vertical distance between the tank's ceiling and its bottom.

In another embodiment, one or more filtering meshes are used in the cracking tank.

In another embodiment, the second processing section is a two-layer structure. The upper layer includes an array of drip holes. The lower layer is a chamber installed with an array of pile units for microbial enzymatic hydrolysis. The nutrient solution is supplied to the pile units via the drip holes.

In another embodiment, the outer circumference of the upper end of the second portion of pipe is convex upward with a flange, and the nutrient solution storage cavity, as a reservoir, is correspondingly formed.

In another embodiment, the upright post is sheathed with an enzyme bacterial sheath.

Yet in another embodiment, the computer compares in real time the ratio VOC content in the outlet end and the inlet end, and when the ratio is higher than a predetermined value, nutrient solution is added into the nutrient supplying tank, and enzyme solution is added to the cracking tank.

The beneficial effect of the system according to the invention is multifold. First, it pre-processes the exhaust gas by applying lytic enzyme solution to VOC. Second, it uses certain microbes to gnaw the VOC particles. Third, both the lytic enzyme solution and the microbial nutrient solution are circularly used. Fourth, the supplies of the lytic enzyme solution and the microbial nutrient solution are controlled by the computer.

### BRIEF DESCRIPTION OF THE DRAWINGS

FIG. 1 is a schematic diagram illustrating the industrial VOC processing system according to the present invention;

FIG. 2 is a schematic block diagram illustrating the structure of a typical preferred embodiment of the industrial VOC processing system according to the invention;

FIG. 3 is a schematic diagram illustrating a typical structure of the second portion of the pipe in the second processing section of the industrial VOC processing system according to the invention;

FIG. 4 is a schematic diagram illustrating a typical structure of the biodegradation chamber in the second processing section of the industrial VOC processing system according to the invention;

FIG. 5 is a schematic diagram illustrating a typical structure of the enzyme sheath used on the upright posts in the biodegradation chamber in the second processing section of the industrial VOC processing system according to the invention;

FIG. 6 is a schematic block diagram illustrating the implementation of a preferred embodiment of the industrial VOC processing system according to the invention.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

The present invention provides an industrial VOC processing system, which includes a first processing section, a second processing section, a sensor detection device, a computer, and an electrical fan. The first processing section and the second processing section are incorporated in a pipe structure for exhaust in production shop. The first processing section is coupled to the inlet end of the exhaust pipe and the second processing section is coupled between the first processing section and the outlet end of the exhaust pipe. In the first processing section, the dust and macromolecules in VOC are eliminated by spraying a cracking solution over the exhaust. In the second processing section, the small molecules in VOC are eliminated by microbes. The electrical fan acts on the exhaust gas so that the gas passes through the first processing section and the second processing section.

The first processing section includes a first section of the pipe where a spraying chamber is installed, a spray device fixed within the upper portion of the spraying chamber, and a cracking tank which is mechanically coupled underneath the first section of the pipe. The cracking tank and the spraying chamber are hydromechanically connected via a first conduit and a second conduit. The cracking tank includes a first pump and a reservoir for containing lytic enzyme solution. The first pump is hydromechanically coupled to the spray device in the first section of the pipe. When the fan is turned on, the exhaust gas is sucked into the chamber through the inlet. At the same time, the first pump pumps the lytic enzyme solution to the spray device via the second conduit. The spray device sprays the lytic enzyme solution over the exhaust that passes through the chamber and the lytic enzyme solution falling to the bottom of the chamber returns to the cracking tank via the first conduit. The lytic enzyme solution is circularly used from the spray chamber to the cracking tank and then to the spray chamber. The exhaust gas that is passing through the spraying chamber is then forced into the second processing section.

The second processing section includes a second section of the pipe constituting a biodegradation chamber and a nutrient supplying tank which is mechanically coupled underneath the biodegradation chamber. The biodegradation chamber and the nutrient supply tank are hydromechanically connected via a third conduit and a fourth conduit. The biodegradation chamber includes an array of pile units for microbial enzymatic hydrolysis. Each pile unit is a rotatable upright post. Microbes that gnaw VOC adhere to the exterior surface of the post. The supplying tank includes a second pump that pumps the nutrient solution up to an upper reservoir in the upper portion of the degradation chamber via the third conduit. The upper reservoir is connected to each pile unit via a microtube or a drip hole. The nutrient solution is supplied to the pile unit periodically. The nutrient solution reaching to the bottom of the degradation chamber returns to the nutrient supplying tank via a fourth conduit. The nutrient solution is circularly used from the supplying tank to the degradation chamber and then to the supplying tank. The VOC in the gas that is passing through the degradation chamber is degraded and eliminated. Clean air comes out from the outlet of the degradation chamber.

The sensor detection device includes a first sensor installed in the inlet of the first processing section and a second sensor installed in the outlet of the second processing section. The sensors collect the VOC data and send the data to the computer that processes the data.

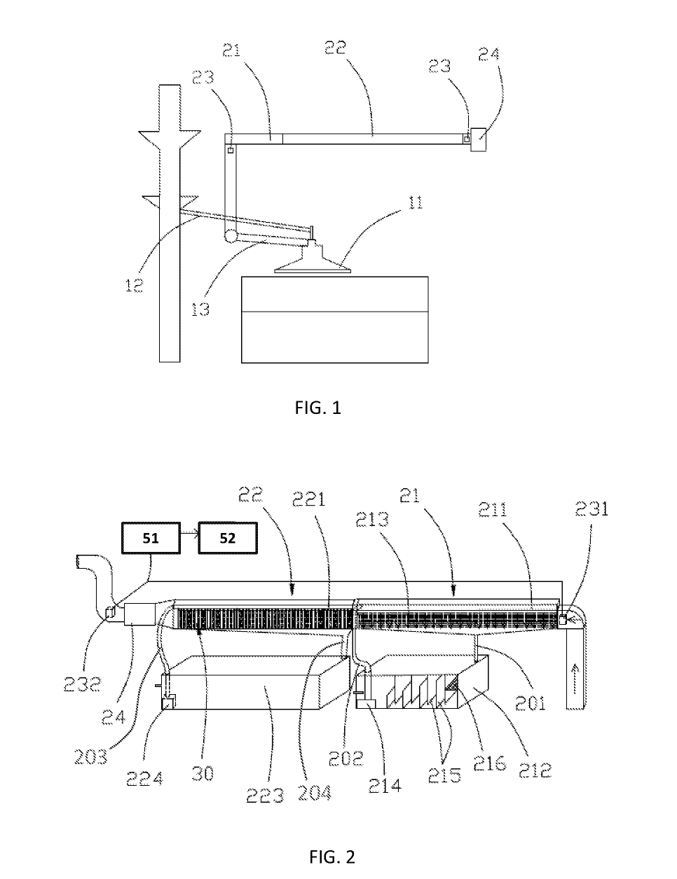

Referring to FIG. 1, which is a schematic diagram illustrating the industrial VOC processing system according to a typical preferred embodiment of the present invention. The system includes a mobile arm 12 which holds a gas suction hood 11. The suction hood 11 sucks the exhaust gas into the processing system via the pipe 13. The suction hood 11 can be easily moved over an industrial assembly line or a working table or other type of exhaust source, to suck exhaust and other harmful gases into the system which is incorporated with the exhaust pipe. In a typical implementation, the mobile arm 12 is mechanically coupled to a support post or a support frame at one end, and to the suction hood 11 with the other end. The mobile arm 12 swings relative to the support so that the suction hood 11 can be moved to the appropriate position over the source of the exhaust or harmful gas. The exhaust gas is then sucked into the processing system through the pipe 13 which is coupled between the inlet of the processing system and the suction hood 11.

The system according to this invention includes a first processing section 21, a second processing section 22, a sensor detection device 23, a computer (not shown in FIG. 1) communicatively coupled to the sensor detection device 23 and an electrical fan 24.

Referring to FIG. 2, which is a schematic block diagram illustrating the structure of a typical preferred embodiment of the industrial VOC processing system according to the present invention, the first processing section 21 includes a first section of pipe 211, a spraying device (not shown in FIG. 2) which is fixed in the upper ceiling of the first section of pipe 211, and a cracking tank 212 which is fixed under the section of pipe 211. More specifically, the first section of pipe 211 is horizontally separated into an upper portion where the spraying device with an array of nozzles or sprinklers are fixed, and a lower portion which is a chamber through which the exhaust gas passes. While the exhaust gas passes through the chamber, the dust and the macromolecules in the VOC are washed down into the cracking tank 212 via the conduit 201 which is coupled between the spraying chamber and the cracking tank 212. The macromolecules in the VOC are then decomposed by the lytic enzyme solution, such as aromatic hydrocarbons, in the cracking tank 212. In a typical implementation, the bottom of the chamber is inclined or caved toward the entrance of the conduit 201 at an angle of 15-20 degrees such that the solution from the spraying device flows into the conduit 201. Optionally, an activated carbon layer 213 is installed in the spraying chamber. The pump 212 pumps the lytic enzyme solution in the cracking tank 212 up to the spraying device via the conduit 202. When the exhaust gas passes through the spraying chamber, the spraying devices sprays the lytic enzyme solution overs the exhaust gas and washes the macromolecules in the VOC down to the cracking tank 212, and the pump 212 further pumps the lytic enzyme solution to the spraying device. Thus, the lytic enzyme solution is circularly used.

To increase the cracking efficiency, the cracking tank 212 includes an array of baffles 215 that alternately coupled to the cracking tank's ceiling and bottom. The baffles 215 coupled to the tank's ceiling have an identical length and thus the gap between the bottom and each of this group of baffles is identical. The height of the baffles coupled to the tank's bottom gradually decreases from the inlet side to the outlet side. In this manner, the solution passes through the wavy pass defined by the baffles, the tank's ceiling and the tank's bottom. Optionally, one or more filtering meshes 216 are used in the cracking tank 212. The filtering meshes are preferably installed in the cracking camber 212's front end that is coupled to the conduit 201. The baffles are paralleled to each other and each baffle's height is shorter than the vertical distance from the tank's bottom to its ceiling.

In operation, the lytic enzyme solution level is monitored and controlled by the sensors 231-232 and the computer 52 which is communicatively coupled to the sensors 231-232 via Internet 50. If it is lower than a predetermined value, more lytic enzyme solution is added to the cracking tank 212.

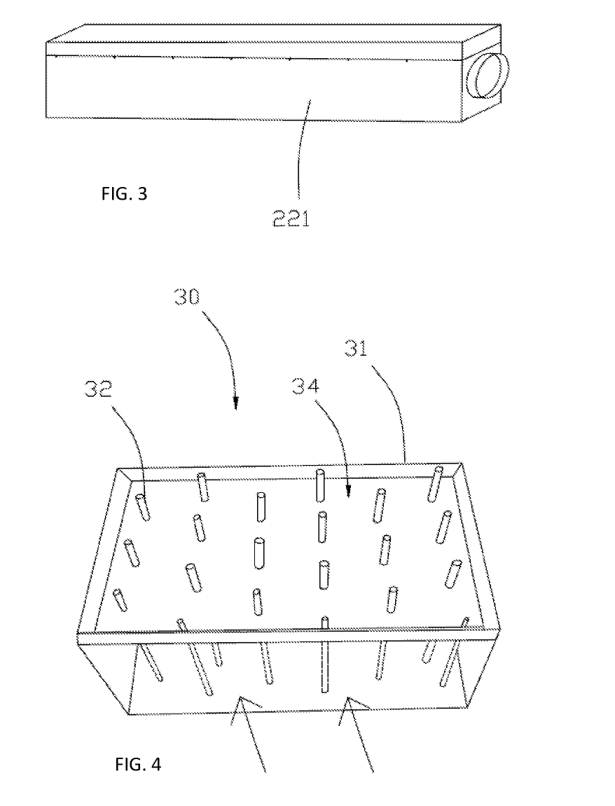

After passing the spraying chamber in the first processing section 21, the gas enters the second processing section 22 wherein the small molecules in the VOC are decomposed by microbes. Referring to FIGS. 2-5, the second processing section 22 includes a second section of the pipe 221 constituting a biodegradation chamber 30 and a nutrient supplying tank 223 which is mechanically coupled underneath the second section of the pipe 221. The biodegradation chamber 30 includes an array of pile units 32 for microbial enzymatic hydrolysis. Each pile unit can be a rotatable upright post. Microbes that gnaw VOC adhere to the exterior surface of the post. A second pump 224 pumps the nutrient solution in the supplying tank 223 to an upper reservoir in the upper portion of the second processing section via the third conduit 203. There is an array of dripping holes on the ceiling of the degradation chamber 30. Each dripping hole is mechanically coupled to the upper reservoir. Each dripping hole is immediately above a pile unit 32 such that the nutrient solution may operably drip to the pile unit. The nutrient solution is supplied to the pile unit periodically. The nutrient solution that reaches the bottom of the degradation chamber 30 returns to the nutrient supplying tank 223 via a fourth conduit 204. The nutrient solution is circularly used. The VOC in the gas that passes through the degradation chamber 30 is degraded and eliminated. Clean air comes out from the outlet of the degradation chamber 30. In a typical implementation, the bottom of the chamber 30 is inclined or caved toward the entrance of the conduit 204 at an angle of 15-20 degrees such that the nutrient solution that reaches the bottom of the chamber 30 flows into the conduit 204 and then into the supplying tank 223.

Referring to FIG. 4, which is a schematic diagram illustrating a typical structure of the biodegradation chamber 30 in the second processing section 22 of the industrial VOC processing system according to a typical implementation of the present invention. The biodegradation chamber 30 includes a box structure 31 and an array of pile units 32. The box structure 31 has a first opening as an entrance of gas and a second opening as an outlet. In the place above the ceiling of the degradation chamber 30 is an assembly for distribution of the nutrient solution including an array of microtubes coupled between the upper reservoir 34 mentioned above and the dripping holes above the pile units 32. In a preferred embodiment, the upper reservoir 34 is a flat area immediately above the degradation chamber 30 and the nutrient solution is dripped to the pile units through the dripping holes. The pile units 32 can be arranged in the chamber 31 either in a matrix or a honeycomb. Referring to FIG. 5, each pile unit 32 is an upright post 35 covered with an enzyme sheath 33 which is rotatable around the upper right post 35. The enzyme sheath 33 includes a microbial inoculation coating, the main component of which are fungi that gnaw VOC and prokaryotes that have symbiotic relationship with fungi. The composition of the microbial inoculation coating can be adjusted according to the composition of different VOC sources. In a typical application of the present invention, the microbial inoculation coating can be composite carbon Nano bed. The enzyme bacteria in the nutrient solution nourishes the microbes in the microbial inoculation coating. The nutrient solution contains trace amounts of minerals, carbohydrates and enzymes for stabilizing and accelerating microbial community metabolism. VOCs are foods of the microbes. In operation, the nutrient solution is dripped to the upright post 35 and then seeped through the enzyme sheath 33. Microbes in the enzyme sheath 33 reproduce and gnaw VOC. The wind caused by the fan rotates the enzyme sheaths such that the nutrient solution is absorbed evenly. The extra nutrient solution that reaches to the bottom of the degradation chamber flows back to the supplying tank 223 via the third conduit 203. The second pump 224, controlled by the computer, pumps up the nutrient solution in the supplying tank 223 to the reservoir above the degradation chamber through the fourth conduit 204. The nutrient solution is circularly used from the supplying tank 223 to the degradation chamber 30 and then back to the supplying tank 223.

Since a certain amount of the nutrient solution will be lost in the operation, a supplying device (not shown in FIG. 2) will be automatically activated to add nutrient solution to the supplying tank 223. As an example, the solution level in the supplying tank 223 is monitored by an electromagnetic induction or a float valve, and when it is lower than a preset value, the supplying device is turned on.

The sensor detection device 23 includes a first sensor 231 and a second sensor 232. The first sensor 231 is fixed in the entrance of the first section of the pipe 211 and collects the data related to content of the organic gas in the entrance. The second sensor 232 is fixed in the outlet of the second section of the pipe 221 and collects the data related to content of the organic gas in the outlet. The computer then calculates the ratio of the VOC parameters of the inlet and the outlet. When the ratio is larger than a predetermined value, the computer activates the corresponding pump to add lytic enzyme solution to the cracking tank 212 and/or to add nutrient solution to the supplying tank 223.

The fan 24 is preferably installed in the outlet of the second section of pipe 221 and the second sensor 232 is preferably installed between the fan 24 and the out let of the degradation chamber in the second section of pipe 221.

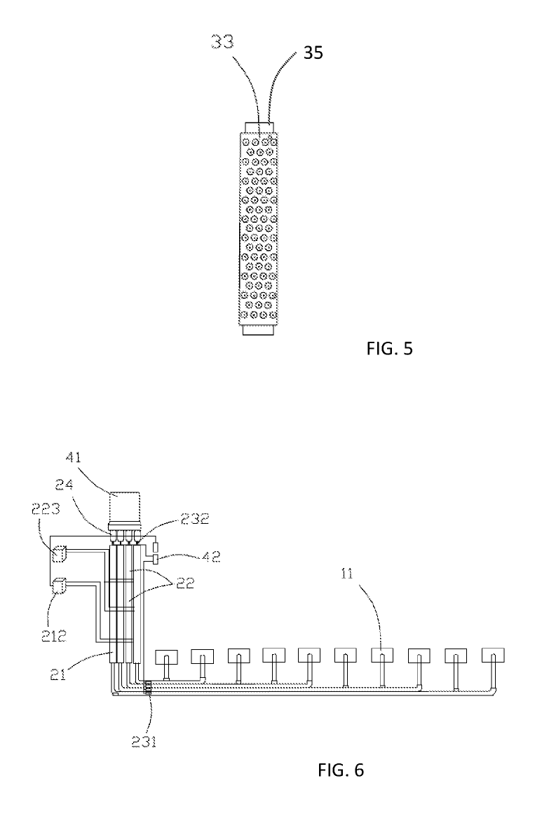

Referring to FIG. 6, which is a schematic block diagram illustrating the implementation of a preferred embodiment of the industrial VOC processing system with a number of movable suction hoods 11, each of which is placed over a VOC source such as a working table in an assembly line. The exhaust gas from each suction hood 11 is preprocessed by lytic enzyme solution in the first processing section 21, and is then processed by microbes in the second processing section 22. A fan 24 is installed in the outlet end of each second processing section 22. The processed gas from each second process section 22 exit into the open air from the shared outlet end 41 of the system. A first sensor 231 is coupled between each suction hood 11 and its corresponding first processing section 21. A second sensor 232 is coupled between each second processing section 22 and its corresponding fan 24. These sensors are electronically coupled to a data center 42 which sends the data to the computer for processing. The shared cracking tank 212 supplies cracking solution to the spraying chamber in each first processing section. The shared nutrient supplying tank 223 supplies enzyme nutrient solution to the biodegradation chamber in each second processing section.

In summary, VOC processing system according to the present invention, which combines a spraying treatment with lytic enzyme solution and biodegradation treatment with microbes, can effectively remove VOC in the industrial exhaust. Since the lytic enzyme solution and the microbial nutrient solution are circularly used and can be automatically replenished, the efficiency is increased.

Although one or more embodiments of the newly improved invention have been presented in detail, one of ordinary skill in the art will appreciate the modifications to the coolant in a liquid cooling system for cooling microelectronic components in computer devices with the addition of silver alloy metal. It is acknowledged that obvious modifications will ensue to a person skilled in the art. The claims which follow will set out the full scope of the claims.

1. A system for processing industrial volatile organic compounds (VOC) in industrial exhaust gas, comprising: a first processing section, a second processing section, a sensor detection device and a computer communicatively coupled to said sensor detection device, wherein said first processing section and said second processing section are incorporated in a pipe structure, wherein said first processing section comprises a spraying chamber wherein lytic enzyme solution is sprayed over the exhaust gas that passes through said spraying chamber, wherein said second processing section comprises a biodegradation chamber wherein microbial nutrient solution is circularly used for nourishing microbes that gnaw VOC particles in the exhaust gas that enters said biodegradation chamber from said first processing section, wherein said sensor detection device comprises a first sensor and a second sensor, said first sensor being fixed in said pipe structure's inlet end, and said second sensor being fixed in said pipe structure's outlet end, and wherein said computer processes data received from said first and said second sensors.

2. The system of claim 1, wherein an array of sprinklers is installed in an upper portion of said first processing section.

3. The system of claim 1, further comprising a cracking tank which is hydromechanically coupled to said spraying chamber's bottom via a first conduit and to said array of sprinklers via a second conduit, wherein a first pump is coupled between said cracking tank and said second conduit, wherein lytic enzyme solution is pumped up by said first pump to said array of sprinklers via said second conduit, falling down to said spray chamber's bottom then flowing back to said cracking tank via said first conduit.

4. The system of claim 3, wherein said spraying chamber's bottom comprises inclined surfaces toward an entrance of said first conduit connecting to said spraying chamber's bottom.

5. The system of claim 1, wherein said spraying chamber is covered with an activated carbon layer.

6. The system of claim 3, wherein said cracking tank comprises an array of paralleled baffles that alternately coupled to said cracking tank's ceiling and bottom, each of said baffles being shorter than a distance between said cracking tank's ceiling and bottom, wherein said baffles coupled to said cracking tank's ceiling have identical height, wherein said baffles coupled to said cracking tank's bottom have different heights gradually decreasing from said cracking tank's inlet side to said cracking tank's outlet side, wherein lytic enzyme solution passes through gaps between each baffle and said cracking tank's bottom.

7. The system of claim 3, wherein said cracking tank comprises one or more filtering mesh installed against said lytic enzyme solution's flow.

8. The system of claim 1, wherein said second processing section comprises a flat reservoir above said biodegradation chamber's ceiling, an array of drip holes on said biodegradation chamber's ceiling and an array of pile units for microbial enzymatic hydrolysis, each of said drip holes being corresponding to one of said pile units, wherein nutrient solution is supplied to said pile units via said drip holes.

9. The system of claim 8, wherein each of said pile units for microbial enzymatic hydrolysis comprises an upright post sheathed with an enzyme bacterial sheath.

10. The system of claim 1, further comprising a nutrient solution supply tank which is hydromechanically coupled to said flat reservoir via a third conduit and to said biodegradation chamber's bottom via a fourth conduit, wherein a second pump is coupled between said supply tank and said third conduit, wherein nutrient solution is pumped up by said second pump to said flat reservoir via said third conduit, falling to said biodegradation chamber's bottom along said upright posts, then flowing back to said supply tank via said fourth conduit.

11. The system of claim 10, wherein said biodegradation chamber's bottom comprises inclined surfaces toward an entrance of said fourth conduit connecting to said biodegradation chamber's bottom.

12. The system of claim 10, wherein said nutrient solution contains trace amounts of minerals, carbohydrates and enzymes for stabilizing and accelerating microbial community metabolism.

13. The system of claim 10, wherein said computer compares in real time a ratio of VOC content in said outlet end and said inlet end, and when said ratio is higher than a predetermined value, nutrient solution is added into said nutrient supply tank, and enzyme solution is added to said cracking tank.

14. The system of claim 1, further comprising a fan installed in said outlet end.
